(19) United States
(12) Patent Application Publication
(10) Pub. No.: US 2005/0206345 A1
(43) Pub. Date: Sep. 22, 2005

(54) Power management method for an electronic apparatus

(76) Inventors: Arif Maskatia, Milpitas, CA (US); Phil Mummah, Redwood City, CA (US); Mark Handa, Danville, CA (US)

Correspondence Address: Michael D. Bednarek;SHAW PITMAN LLP, 1650 Tysons Blvd., McLean, VA, 22102, US

(21) Appl. No.: 10/802,873

(22) Filed: Mar. 18, 2004

(51) Int. Cl. H02J 7/00

(52) U.S. Cl. 320/132

(57) ABSTRACT

A power management method for an electronic apparatus powered by a battery unit and installed with an operating system includes the steps of inputting a user-defined remaining capacity for the battery unit into the electronic apparatus, and reporting the user-defined remaining capacity to the operating system. The operating system supports a power management specification and is operable so as to obtain an actual remaining capacity of the battery unit. When the operating system compares the user-defined remaining capacity with a reference value according to the power management specification, and determines the user-defined remaining capacity to be lower than the reference value, the operating system enables operation of the electronic apparatus in a low power consumption mode.

### BACKGROUND OF THE INVENTION

1. Field of the Invention

The invention relates to a power management method, more particularly to a power management method for an electronic apparatus that is powered by a battery unit.

2. Description of the Related Art

A conventional power management method, which complies with an Advanced Configuration and Power Interface (ACPI) specification, reduces power consumption of a notebook computer powered by a battery unit so as to extend battery run time of the battery unit. The conventional power management method involves enabling operation of the notebook computer to operate in a low power consumption mode when there is no system activity for a predetermined period of time. Furthermore, hardware devices connected to the notebook computer are turned off without user involvement when they are not in use for a predetermined period of time. The hardware devices include a hard disk drive, a floppy disk drive, an optical disc drive, a modem, a network card, a card bus socket, a USB connector, a 1394 firewire connector, a flash memory socket, and a computer mouse, etc.

Although the conventional power management method achieves its intended purpose, it does not permit the user to reconfigure as to when the notebook computer should be operating in the low power consumption mode, and as to which ones of the hardware devices should be turned off.

### SUMMARY OF THE INVENTION

Therefore, the object of the present invention is to provide a user-reconfigurable power management method for an electronic apparatus that is powered by a battery unit.

According to one aspect of the present invention, a power management method for an electronic apparatus powered by a battery unit and installed with an operating system comprises the steps of inputting a user-defined remaining capacity for the battery unit into the electronic apparatus, and reporting the user-defined remaining capacity to the operating system. The operating system supports a power management specification and is operable so as to obtain an actual remaining capacity of the battery unit and so as to display the actual remaining capacity of the battery unit on a display device. When the operating system compares the user-defined remaining capacity with a reference value according to the power management specification, and determines the user-defined remaining capacity to be lower than the reference value, the operating system enables operation of the electronic apparatus in a low power consumption mode.

According to another aspect of the present invention, a power management method for an electronic apparatus powered by a battery unit and installed with an operating system comprises the step of inputting a user-defined threshold value into the electronic apparatus. The operating system supports a power management specification and is operable so as to obtain a remaining capacity of the battery unit. When the operating system compares the remaining capacity of the battery unit with the user-defined threshold value according to the power management specification, and determines the remaining capacity of the battery unit to be lower than the user-defined threshold value, the operating system enables operation of the electronic apparatus in a low power consumption mode.

### BRIEF DESCRIPTION OF THE DRAWING

Other features and advantages of the present invention will become apparent in the following detailed description of the preferred embodiment with reference to the accompanying drawings, of which:

FIG. 1 is a schematic circuit block diagram of an electronic apparatus that performs the preferred embodiment of a power management method according to the present invention; and

FIGS. 2 and 3 are flowcharts of the preferred embodiment of the power management method according to the present invention.

### DETAILED DESCRIPTION OF THE PREFERRED EMBODIMENT

The preferred embodiment of a power management method is applied to an electronic apparatus.

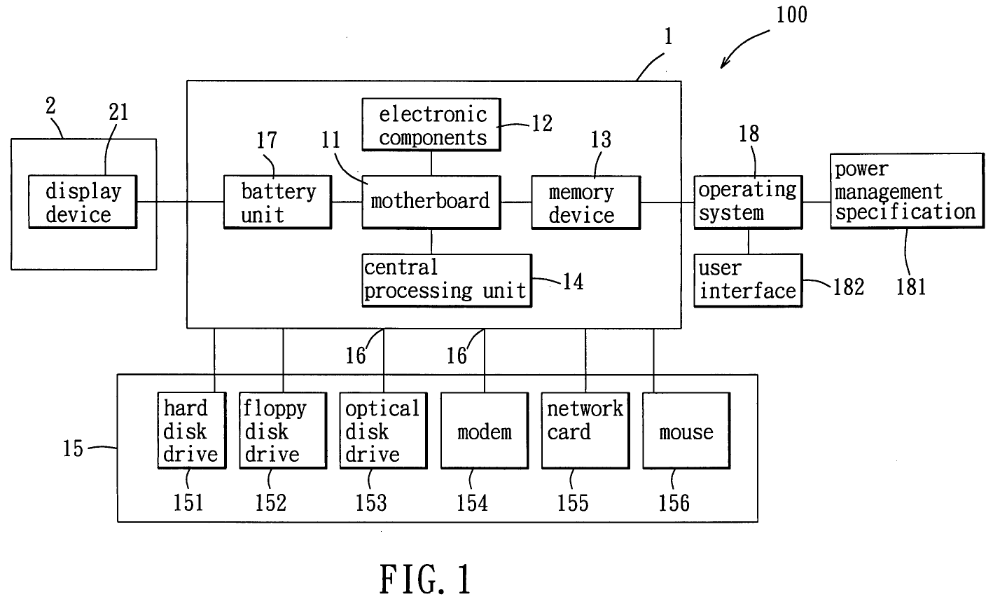

Referring to FIG. 1, the electronic apparatus 100 is powered by a battery unit 17 and is installed with an operating system 18. In this embodiment, the electronic apparatus 100 is embodied in a notebook computer that includes a host module 1 and a display module 2. The host module 1 includes a motherboard 11 mounted with a plurality of electronic components 12. The electronic apparatus 100 includes a memory device 13 mounted on the motherboard 11 and coupled electrically to the electronic components 12, a central processing unit 14 mounted on the motherboard 11 and coupled to the electronic components 12, and a plurality of hardware devices 15, each of which is connected to the motherboard through a corresponding port 16 and is coupled to the electronic components 12. The hardware devices 15 include known peripherals, such as a hard disk drive 151, a floppy disk drive 152, an optical disc drive 153, a modem 154, a network card 155, cardbus socket (not shown), a USB connector (not shown), a 1394 firewire connector (not shown), a flash memory socket (not shown), and a computer mouse 156, etc. The display module 2 is connected pivotally and electrically to the host module 1, and includes a display device 21.

In this embodiment, the operating system 18 of the electronic apparatus 100 supports a power management specification 181. Preferably, the power management specification 181 is an Advanced Configuration and Power Interface (ACPI) specification. Furthermore, the operating system 18 is operable so as to obtain an actual remaining capacity of the battery unit 17 and so as to display the actual remaining capacity of the battery unit 17 on the display device 21 in a conventional manner.

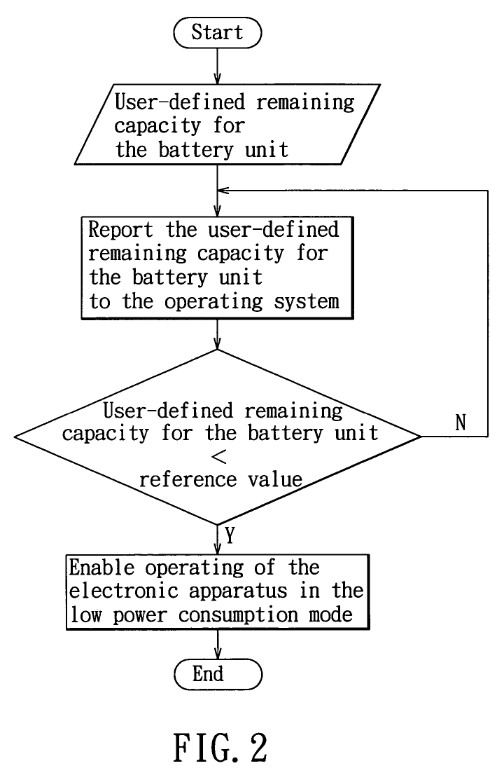

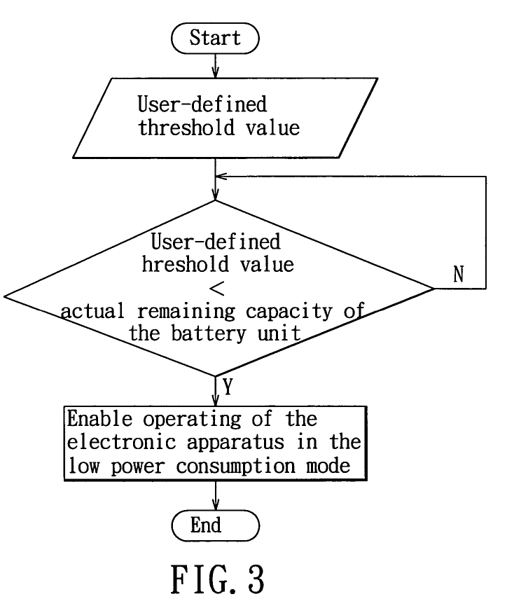

With further reference to FIGS. 2 and 3, the power management method of the preferred embodiment begins with the input of one of a user-defined remaining capacity for the battery unit 17 and a user-defined threshold value. When the user-defined remaining capacity is inputted, as best shown in FIG. 2, the user-defined remaining capacity is reported to the operating system 18. At this time, the operating system 18 compares the user-defined remaining capacity with a reference value according to the power management specification 181. When the operating system 18 determines the user-defined remaining capacity of the battery unit 17 to be lower than the reference value, the operating system 18 switches operation of the electronic apparatus 100 from a high power consumption mode to a low power consumption mode.

When the user-defined threshold value is inputted, as best shown in FIG. 3, the operating system 18 compares the actual remaining capacity of the battery unit 17 with the user-defined threshold value according to the power management specification 181. When the operating system 18 determines the actual remaining capacity of the battery unit 17 to be lower than the user-defined threshold value, the operating system 18 switches operation of the electronic apparatus 100 from the high power consumption mode to the low power consumption mode.

The input of the user-defined remaining capacity for the battery unit 17 and the user-defined threshold value are conducted through a user interface 182.

It has thus been shown that the power management method of this invention permits the user to input a user-defined remaining capacity for the battery unit 17 or a user-defined threshold value for enabling the electronic apparatus 100 to operate in the low power consumption mode. As such, power consumption of the electronic apparatus 100 is reduced, thereby lengthening run time of the battery unit 17.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A power management method for an electronic apparatus powered by a battery unit, the electronic apparatus being installed with an operating system that supports a power management specification and that is operable so as to obtain an actual remaining capacity of the battery unit and so as to display the actual remaining capacity of the battery unit on a display device, said method comprising the steps of:
(A) inputting a user-defined remaining capacity for the battery unit into the electronic apparatus; and
(B) reporting the user-defined remaining capacity to the operating system such that when the operating system compares the user-defined remaining capacity of the battery unit with a reference value according to the power management specification and determines the user-defined remaining capacity to be lower than the reference value, the operating system enables operation of the electronic apparatus in a low power consumption mode.

2. The power management method in claim 1, wherein the power management specification is an Advanced Configuration and Power Interface (ACPI) specification.

3. The power management method in claim 1, wherein the user-defined remaining capacity is inputted through a user interface.

4. A power management method for an electronic apparatus powered by a battery unit, the electronic apparatus being installed with an operating system that supports a power management specification and that is operable so as to obtain a remaining capacity of the battery unit, said method comprising the step of:
inputting a user-defined threshold value into the electronic apparatus such that when the operating system compares the remaining capacity of the battery unit with the user-defined threshold value according to the power management specification and determines the remaining capacity of the battery unit to be lower than the user-defined threshold value, the operating system enables operation of the electronic apparatus in a low power consumption mode.

5. The power management method in claim 4, wherein the power management specification is an Advanced Configuration and Power Interface (ACPI) specification.

6. The power management method in claim 4, wherein the threshold value is inputted through a user interface.

7. A power management method for an electronic apparatus powered by a battery unit, the electronic apparatus being installed with an operating system that supports a power management specification and that is operable so as to obtain an actual remaining capacity of the battery unit and so as to display the actual remaining capacity of the battery unit on a display device, said method comprising the steps of:
(A) inputting one of a user-defined remaining capacity for the battery unit and a user-defined threshold value into the electronic apparatus;
(B) when the user-defined remaining capacity is inputted, reporting the user-defined remaining capacity to the operating system such that when the operating system compares the user-defined remaining capacity with a preset reference value according to the power management specification and determines the user-defined remaining capacity to be lower than the reference value, the operating system enables operation of the electronic apparatus in a low power consumption mode; and
(C) when the user-defined threshold value is inputted, enabling the operating system to compare the actual remaining capacity of the battery unit with the user-defined threshold value according to the power management specification such that the operating system enables operation of the electronic apparatus in the low power consumption mode when the operating system determines the actual remaining capacity of the battery unit to be lower than the user-defined threshold value.

8. The power management method in claim 7, wherein the power management specification is an Advanced Configuration and Power Interface (ACPI) specification.
